(19) United States
(12) Patent Application Publication
(10) Pub. No.: US 2007/0001064 A1
(43) Pub. Date: Jan. 4, 2007

(54) Nursing bottle restrainer

(76) Inventors: Veijo Matias Tuoriniemi, Summit, NJ (US); Cornelia Frances Tuoriniemi, Summit, NJ (US)

Correspondence Address: VEIJO M. TUORINIEMI, 47 WOODLAND AVE., APT 107, SUMMIT, NJ, 07901, US

(21) Appl. No.: 11/430,499

(22) Filed: May 9, 2006

Related U.S. Application Data
(60) Provisional application No. 60/679,079, filed on May 9, 2005.

(51) Int. Cl. A47D 15/00; A61J 9/06

(52) U.S. Cl. 248/102; 248/107

(57) ABSTRACT

A infant nursing bottle restrainer preventing a nursing bottle from falling on the floor or ground, having an elastic O-ring which can be stretched around the bottle and been able to recover and fit to a thinner part of the bottle. The restrainer has an integrally formed cord having a first end attached to the elastic O-ring and a second end which can be attached to a secure holding means. In a molding process the elastic O-ring and the cord are joined integrally and uniformly together.

This application claims priority from U.S. Provisional Application No. Patent 60/679,079 filed May 9, 2005 fully enclosed here as reference.

### FIELD OF INVENTION

Disclosed invention relates to nursing bottle restrainers preventing an infant from loosing a bottle on the floor or on the ground when being fed in a stroller, high chair, car seat or other such seat. The invention can also been used to hold toys from falling, or with a shorter cord it can be used to hook a bottle to a belt.

### BACKGROUND OF THE INVENTION

Purpose of a restrainer is to prevent a nursing bottle from falling to the ground, floor, or under the car seats and keep the bottle clean from germs or preventing the bottle from getting lost.

### CROSS REFERENCE TO RELATED APPLICATIONS

U.S. Pat. Nos. 2,815,909, 3,065,944, 3,827,790, 4,946,119, 4,498,613, 4,989,811, 5,082,220

U.S. Pat. No. 4,416,438 discloses a bottle holder with elongated flexible member having a slidable loop at one end for securing about the neck of a feeding bottle, and an anchoring suction cup at the other end.

U.S. Pat. No. 5,613,657 shows a semi rigid bottle fastening ring attached to first end of a polypropylene strap and an adjustable, quick release fastening device at the other end of the strap. A bottle retaining device with a rigid or semirigid device cannot be attached to a bottle or removed from the bottle without opening of the nipple holder ring of the bottle first.

U.S. Pat. No. 6,606,768 describes a flexible strap made out of woven fabric having an elastic loop as a securing means on both ends and two hook and loop attachment means integral or attached to the flexible strap being able of mating each others.

However, the woven fabric is expensive to manufacture and forming of loops to the ends need sewing work as well as attaching of Velcro® to the flexible strap between the loops. Woven strap has structured surface which gets dirty soon, cannot be wiped totally clean, and need frequent washing.

Primary attachment loop is made of flat and wide elastic strap, which is too wide be secured to the narrow space between the nipple holder and the bottle. Loop is attached merely by friction and can easily slide away from it's position resulting lost of the item. The attachment means to the bottle is same as in U.S. Pat. No. 3,977,638 describing a flexible strap with flattened loop of elastic strip material in the end of a flexible strap. Elastic material is made of material commonly used to form garters and various other elastic bands of an apparel nature including suspenders and the like. The bottle is held in the elastic loop by friction. However, this type of materials, like spandexes combined with woven material often looses the elasticity at least partially after being washed. Eventually the loop might not be able to hold the bottle by friction anymore.

### OTHER PRIOR ARTS

Bottle Bungee sold by www.inventiveparent.com/bottlebungee.htm.

In general prior art restraines are made on unhygienic fabric or webbing which need to be washed in a laundry machine. Manufacturing of them requires cutting of the fabric or webbing and sewing the parts and velcro together. In some cases also plastic molding is needed to make the semi rigid bottle holder ring.

### OBJECTS AND ADVANTAGES

The present invention provides an economical way to manufacture a nursing bottle restrainer in one process. The restrainer can be washed in a dishwasher easily in a same process than bottles and nipples are washed. Smooth unstructured surface can be wiped clean, rinsed and shaken dry easily. Molded silicone will hold its shape and elasticity even in dishwasher temperature. Thin bottle holding ring is snapfitting between or the nipple holding ring and the bottle or behind the nipple holding ring and securing the

### DRAWING FIGURES

FIG. 1 shows a perspective view of the first embodiment with The O-ring stretched over the bottle neck and distal end with loop attached to a stroller frame.

FIG. 2 shows a perspective view of the second embodiment with open, unlooped distal end attached to a stroller frame.

FIG. 3 shows a front elevational and side elevational view of the bottle restrainer

FIG. 4 shows a perspective view of the bottle restrainer with the cord attached mechanically to the O-ring.

FIG. 5 shows a perspective view of the bottle restrainer with the cord attached mechanically to the O-ring and having a looped distal end.

FIGS. 6a-6c show a different ways to form a mold for the restrainer. The Restrainer can be molded having the cood straight in the mold as shown in

FIG. 6a or it can be molded on form of zig-zag as shown in FIG. 6b or on a coil as shown in FIG. 6c.

### SUMMARY OF THE INVENTION

The disclosed invention describes a economical bottle restrainer which can be formed uniform by molding. The restrainer does not need joints to be formed between the flexible string and securing means in the ends of the strap. The restrainer has an elastic loop on first end of the cord, snap-fitting to the space between the nipple holder and the bottle. Elastic loop can be stretched over the nipple holder ring to its place behind the nipple holder ring where it recovers to it's original shape and securely snaps to the space behind the nipple holder ring. In the other end of the cord the bottle restrainer has preferably an integral loop, which is big enough to be wrapped around a secure object like stroller frame and then the first end of the restrainer been able to be slid through the loop

### DESCRIPTION AND OPERATION OF PREFERRED EMBODIMENT

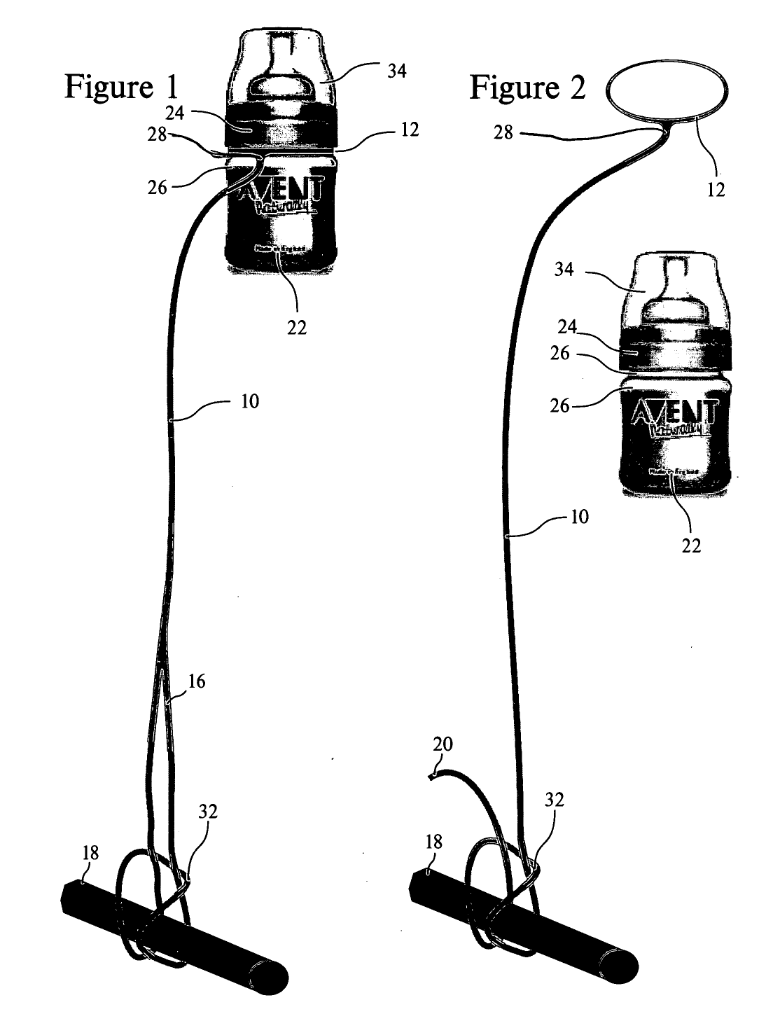

FIG. 1 a shows a preferred embodiment of the invention. The elastic O-ring 12 stretches over a top of a variety of sizes of nursing bottles. After stretching over the protective cap 34 and nipple holder 24 the O-ring recovers its original size. After being stretched or expanded the elastic and flexible O-ring 12 returns to between the nipple holder ring 24 and the bottle 22 without having to open the nippleholder 24 or removing the protective cap 34.

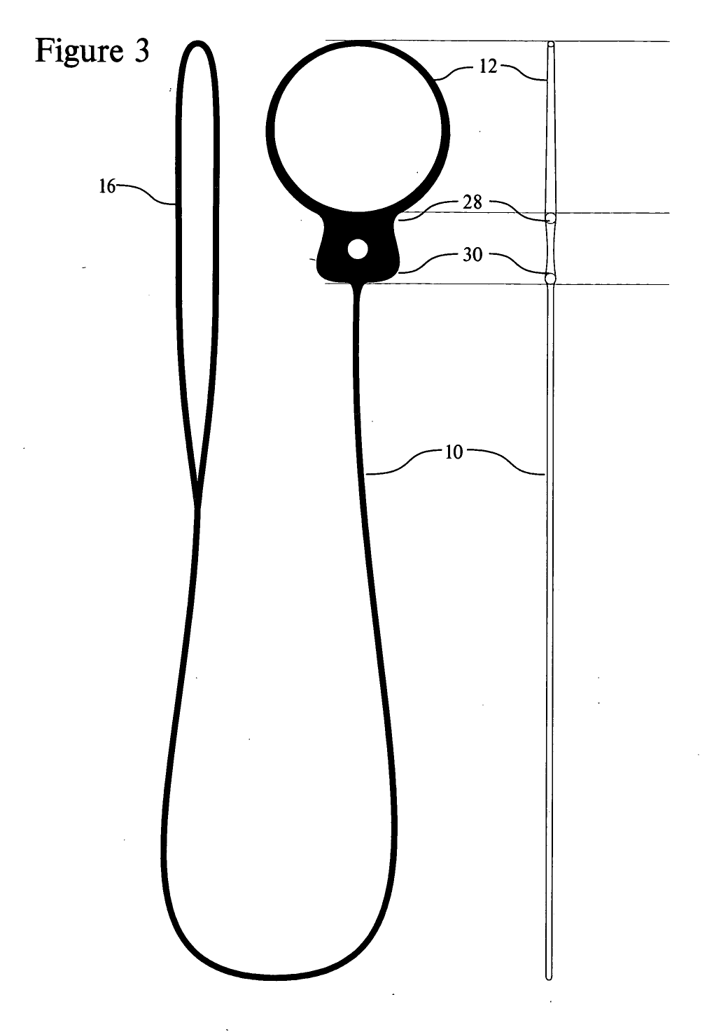

The cord 10 is seamlessly joined to the O-ring 12 in a molding process. The joint 28 may or may not have a finger handle 30, as shown in FIG. 3, to give grip to stretch the O-ring 12 over the nipple holder ring 24 and also strengthening and reinforcing the joint between cord 10 and O-ring 12 when the cord is stretched or pulled.

The length of the cord should be sufficiently long to be able to attached to a stroller frame or a high chair from its distal end 20 and still enabling the baby to drink comfortably from the bottle without tangling to the cord. However the cord should be short enough to prevent the bottle from hitting the ground if baby happens to throw or drop the bottle. Preferably the length of the open end cord from the joint 28 to the distal end 20, or alternatively from the joint 28 to the end of the loop 16, should be between 20-50 cm.

The distal end 20 of the cord can be looped as shown in FIG. 1 or the end can be open as shown in FIG. 2. Both of the endings can be knoted e.g. with a simple and fast Lark's Head knot 32 as shown in FIGS. 1. Looped end cord is preferred. However the open end cord gives advantage to adjust the length of the cord. Cord can be tied by using familiar knots like overhand, timber hitch, lariath loop, clove hitch described in “A Visual Aid for Knot Tying” by Boy Scouts of America.

FIG. 3 shows an elevational front view of the bottle bungee. The diameter of the O-ring 12 is somewhat thicker from the finger handle 30 side than from the opposite side. If the O-ring had a same diameter throughout the perimeter, removing the O-ring from the bottle neck would cause the O-ring to roll around itself and leaving possibly in tensioned stage after removal. Having the O-ring thicker from the handle 30 side will force the opposite end of the ring 12 to unwind the tension. Force caused by thicker, handle 30 side and the tapering shape forces the thinner, opposite site of the O-ring 12 to release the O-ring 12 from rotational tension, which otherwise would occur when removing the O-ring from the bottle neck 26.

The bottle restrainer has a finger handle 30 between the O-ring 12 and the cord 10. The outer periphery of the handle 30 is thicker than the middle of the handle to provide better grip. Indeed, the thicker periphery of the handle 30 can be tappering towards the middle of the handle and the handle can have a hole in the middle of it. Hole is used for maximum grip and it also provides an additional means for additional attachments.

The O-ring 12, handle 30, cord 10 and loop 16 in the end of the loop are formed from silicone by molding. All parts are formed in the same process enabling economical production, since cord does not need to be attached to the bottle holder ring separately and the cord has a loop as an attachment means.

The silicone material to be used is preferably FDA (Food and Drug Administration) approved silicone having a tensile strength suitable for baby not to be able to break it and having elongation % which would enable stretching of the O-ring over most or all standard nursing bottle necks.

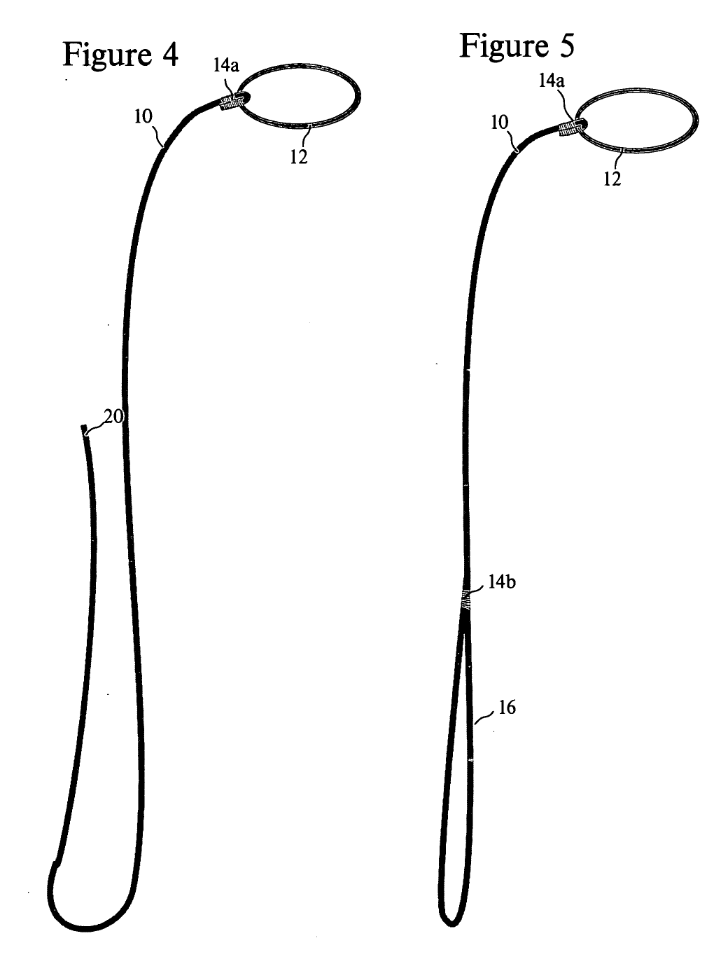

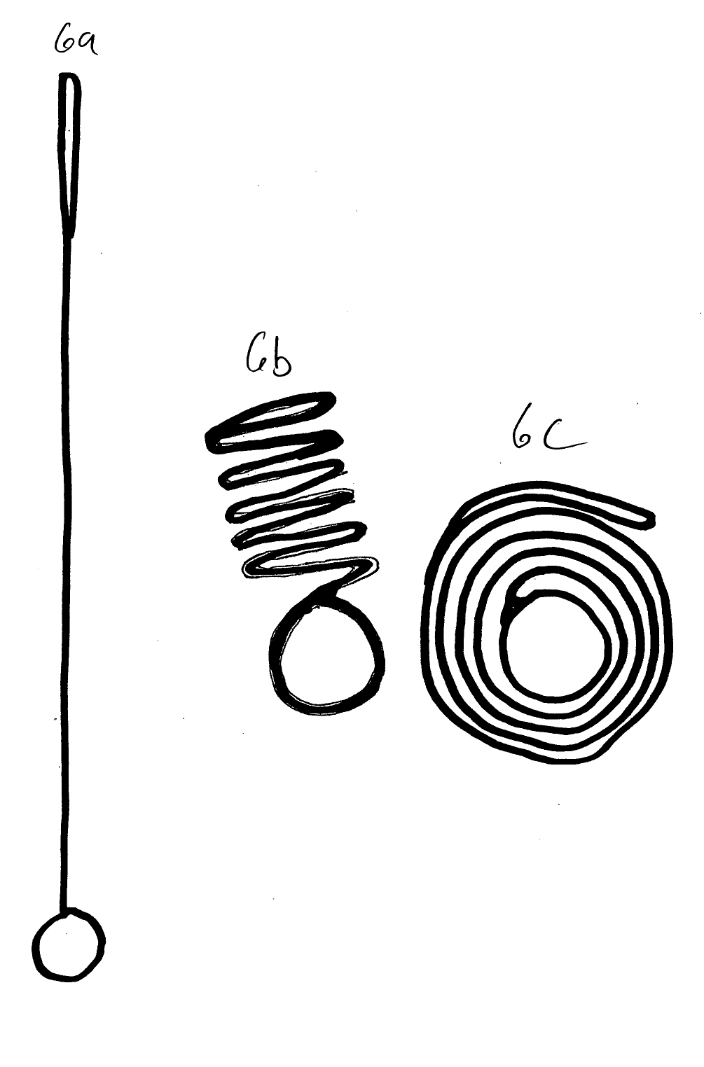

FIG. 5 shows a bottle restrainer where a predetermined length of cord 10 is attached to elastic silicone O-ring 12 by looping it around O-ring 12 and securing a first end of the cord 10 to itself by an attachment means 14a. Distal end 20 of the bungee cord is left unlooped.

The distal end 20 of the cord 10 will be attached e.g. to a stroller frame or high chair as shown in FIG. 1.

O-ring 12 and the cord 10 are combined by hooking the cord 10 around the O-ring 12 and secured in its place by attachment means 14a The elastic O-ring 12 will be stretched around the neck 26 of the bottle 22 in a similar way as shown in the FIG. 1.

FIG. 5 shows the embodiment of the invention wherein the distal end 20 of the cord 10 is made to form a loop 16 and end 20 is secured to the cord 10 by attachment means 14b. A looped distal end of the cord 10 can be attached to the stroller frame 18 more securely by a simple and fast Lark's Head knot than the unlooped end as shown in FIG. 1.

### CONCLUSION, RAMIFICATIONS AND SCOPE

The O-ring will sometimes be taken to the mouth of a child therefore at least the O-ring -utility loop is made of FDA (Food and Drug Administration) approved silicone, but also other elastic plastic and rubber materials can be used. When all parts of the article are molded in the same process all parts will be preferably made of same material.

The diameter of the profile of the O-ring is preferably between 2-5 mm, however, depending on material, thinner or thicker profiles can be employed. The thickness of the seamlessly following cord can vary depending on material. However, it should be at least so thick that infant cannot break it by pulling or biting.

The described useful device can have various practical uses. The restrainer is not limited to boby bottles but it can also been used to keep toys from falling on the ground or floor and prevent them from getting lost.

While the invention has been described with respect to specific embodiments by way of illustration, many modifications and changes will occur to those skilled in art. It is, therefore, to be understood that the appended claims are intended to cover all such modifications and changes as fall within the true scope and spirit of the invention.

### LIST OF REFERENCE NUMERALS

10 Cord
12 O-ring
14a, 14b Attachment Means
16 Loop
18 Stroller Frame
20 Distal End of the Cord
22 Bottle
24 Nipple Holder Ring
26 Bottle Neck
28 Joint of O-ring and Cord
30 Finger Handle
32 Lark's head knot

We claim:

1. A restrainer preventing an infant nursing bottle from falling on the floor or ground having
a) a elastic O-ring which can be stretched around said bottle and by deformation to be able to fit securely to a thinner part of said bottle;
b) a cord having a first end attached to said elastic O-ring and a second end which can be attached to a secure holding means;
said restrainer being formed in a molding process wherein said elastic O-ring and said cord attached to it are joined integrally and uniformly together.

2. A restrainer of claim 1 wherein said restrainer is made out of polymeric material.

3. A restrainer of claim 2 wherein sain polymeric material is silicone.

4. A restrainer of claim 1 wherein said cord has a tensile strength high enough at least to catch a falling nursing bottle but preferably enough to last pulling of an infant without breaking.

5. A restrainer of claim 1 wherein said O-ring has elastic properties enabling it to be stretched over a top part of a variety of nursing bottles and is able to recover and get adapted over the necks of said bottles.

6. A restrainer of claim 1 wherein the second end of the cord has an attachment means to attach the restrainer to said secure holding means.

7. A restrainer of claim 6 wherein said attachment means is a loop being able to be wrapped around a secure holding means and the first end being able to be slid through said loop.
